(19) United States
(12) Patent Application Publication
(10) Pub. No.: US 2004/0061969 A1
(43) Pub. Date: Apr. 1, 2004

(54) Method and structure for operating high density hard disk drive head using piezo electric drive

(75) Inventors: Xiao Yang, Fremont, CA (US); Visit Thaveeprungsriporn, Bangkok (TH); Szu-Han Hu, Bangkok (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, Ayutthaya (TH)

(21) Appl. No.: 10/440,496

(22) Filed: May 15, 2003

Related U.S. Application Data
(60) Provisional application No. 60/415,383, filed on Oct. 1, 2002.

(51) Int. Cl. G11B 5/596

(52) U.S. Cl. 360/78.05; 360/78.12; 360/77.02; 360/77.03

(57) ABSTRACT

A disk drive apparatus. The apparatus has a platter operably coupled to a servo drive device. The servo drive device is adapted to rotate the platter about a fixed axis. The apparatus also has a support member operably coupled to the platter to move the support member about one or more active regions on a surface of the platter. The apparatus has a read/write head including an active portion and a support portion. The support portion is coupled to the support member. The active portion is operably coupled to the platter to read and/or write information to the surface of the platter. A piezo electric actuating material is coupled between the support portion of the read/write head and the support member. A first electrode is coupled to a first side of the piezo electric actuating material. A second electrode is coupled to a second side of the piezo electric actuating material. A drive device is coupled to the first electrode and the second electrode to actuate the piezo electric actuating material in substantially a shear mode of operation of the piezo electric actuating material to adjust a position of the read/write head within one micron of a selected portion of the one or more active regions on the surface of the platter. The first electrode and the second electrode are configured in a manner substantially parallel to a poling orientation of the piezo electric actuating material to cause the adjustment of the piezo electric actuating material in the shear mode of operation.

### BACKGROUND OF THE INVENTION

This invention generally relates to techniques for operating a disk drive apparatus. More particularly, the present invention provides a method and apparatus for reading and writing information onto a computer disk commonly called a hard disk for storing data. Merely by way of example, the present invention is implemented using such method and apparatus with an actuating device coupled between a read/write head and support member for fine tuning the read/write head onto a data track on the hard disk, but it would be recognized that the invention has a much broader range of applicability.

Storage of information has progressed through the years. From the early days, primitive man stored information on walls of caves, as well as used writings on wood such as bamboo. Since then, people have used wood, silk, and papers as a media for writings. Paper has been bound to form books. Information is now stored electronically on disks, tape, and semiconductor devices. As merely an example, some of the early disks used magnetic technology to store bits of information in a digital manner onto the magnetic media. One of the first disk drives was discovered in the 1950's by International Business Machines of Armonk, N.Y.

Although such disks have been successful, there continues to be a demand for larger storage capacity drives. Higher storage capacity can be achieved in part by increasing an aerial density of the disk. That is, the density increases with the number of tracks per inch (TPI) and the number of bits per inch (BPI) on the disk.

As track density increases, however, the data track becomes narrower and the spacing between data tracks on the disk decreases. It becomes increasingly difficult for the motor and servo control system to quickly and accurately position the read/write head over the desired track. Conventional actuator motors, such as voice coil motors (VCM), often lack sufficient resolution and bandwidth to effectively accommodate high track-density disks. As a result, a high bandwidth and resolution second-stage microactuator is often necessary to precisely position the read/write head over a selected track of the disc.

Thus, there is a need for an improved drive apparatus.

### SUMMARY OF THE INVENTION

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

In a specific embodiment, the invention provides a disk drive apparatus, e.g., hard disk drive system. The apparatus has a magnetic disk for storing information, which includes a plurality of tracks, e.g., about 50,000 through 100,000 tracks per inch. The method also includes a movable support member often called Head Gimbal Assembly or HGA coupled to the magnetic disk. The HGA includes a read/write head and a suspension. The suspension is comprised of a trace gimbal or “TG” and a loadbeam. The gimbal has a tongue portion. A slider device is coupled to the tongue portion. A read/write head is coupled to the slider device. The gimbal has certain stiffness that allows the read/write head to pitch and roll around a pivotal point at the center of the tongue. A drive device is coupled between the magnetic disk and the suspension. The primary drive device, e.g., a voice coil motor or VCM, is adapted to move the read/write head on a track on the magnetic disk using the suspension to suspend the read/write head over the disk at a distance of few nanometers. A second stage actuator device is coupled between the slider device and the gimbal. The actuator device is adapted to move the slider relative to the gimbal to a position normal to the track on the magnetic disk to align the read/write head on the track using a finer and faster alignment of the read/write head than the moveable support member driven by the VCM.

In a specific embodiment, a piezoelectric actuating material is coupled between the support portion of the read/write head and the support member. A first electrode is coupled to a first side of the piezo electric actuating material. A second electrode is coupled to a second side of the piezo electric actuating material. A drive device is coupled to the first electrode and the second electrode to actuate the piezo electric actuating material in substantially a shear mode of operation of the piezo electric actuating material to adjust a position of the read/write head within one micron of a selected portion of the one or more active regions on the surface of the platter. The first electrode and the second electrode are configured in a manner substantially parallel to a poling orientation of the piezo electric actuating material to cause the adjustment of the piezo electric actuating material in the shear mode of operation.

In an alternative specific embodiment, the invention provides a method for manufacturing a support member for a read/write head, which forms an integrated support member with actuating member. The method includes providing a support substrate, e.g., stainless steel. The method includes coupling (e.g., adhesive) a piezo electric material having a predetermined thickness onto a surface of the substrate. The piezo electric material includes an electrode material overlying the surface of the substrate. The method includes forming a conductive layer overlying the piezo electric material and patterning the conductive layer to form one or more conductive regions. The method also includes patterning a backside surface of the support substrate to remove a portion of the support substrate up to one or more portions of the one or more conductive regions to substantially free the one or more portions of the one or more conductive regions from the support substrate while maintaining a selected portion of the piezo-electric material intact.

In an alternative specific embodiment, the invention provides a method for operating a disk drive apparatus. The method includes moving a suspension about a fixed position to move a read/write head coupled to a slider to a selected track on a disk. The selected track is at least one of a plurality of tracks. The method includes correcting off-track error of the read/write head using a second stage actuating device coupled between the read/write head and the slider. The actuating step moves the read/write head relative in a manner normal to the track on the magnetic disk to align the read/write head on the track using a finer and faster alignment of the read/write head than the VCM.

In yet an alternative specific embodiment, the invention includes an apparatus for disk drive. A suspension has a first end and a second end. The first end is connected to an arm that is adapted to couple about a pivot region. The second end includes a tongue portion. A slider is coupled to the tongue portion. The slider is capable to acting as an air bearing and a support member. A read/write head is coupled to the slider. An actuating device is coupled between the read/write head and the slider. The actuating device is capable of moving the read/write head in a manner normal to a track on a magnetic disk to align the read/write head to a desired a track on the track to a tolerance of less than 10 nanometers and at a frequency of greater than 5 kHz.

Numerous benefits are achieved using the present invention over conventional techniques. For example, the present invention can be implemented using existing fabrication technologies. Additionally, the present invention can provide for alignment of a read/write head to track density of 250 k TPI (track per inch) or 10 Gbit/in² and greater at 5 kHz or greater. In certain embodiments, the present invention can be implemented using a small form factor, e.g., less than 100 microns in thickness, which results in no change in disk-disk spacing and causes little additional off-track error from “windage effect.” The invention can also be easy to manufacture and apply according to certain embodiments. Depending upon the embodiment, one or more of these benefits may be used. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified top-view diagram of a disk drive apparatus according to an embodiment of the present invention;

FIG. 2 is a more detailed side-view diagram of a disk drive arm assembly according to an embodiment of the present invention;

FIG. 3 is a detailed diagram of a gimbal-actuator-slider assembly according to an embodiment of the present invention;

FIG. 4 is a detailed front-view diagram of a gimbal-actuator-slider assembly according to an embodiment of the present invention;

FIG. 5 is a detailed diagram of a multiplayer PZT actuating device structure according to embodiments of the present invention; and

FIG. 6 is a detailed diagram of piezoelectric actuating device operating modes according to embodiments of the present invention

### DESCRIPTION OF THE SPECIFIC EMBODIMENTS

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

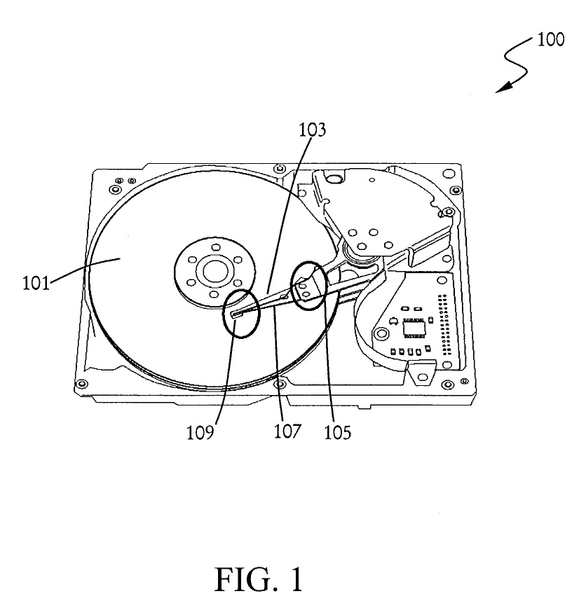

FIG. 1 is a simplified top-view diagram 100 of a disk drive apparatus according to an embodiment of the present invention. This diagram is merely an example, which should not unduly limit the scope of the claims herein. One of ordinary skill in the art would recognize many other variations, modifications, and alternatives. As shown, the apparatus 100 includes various features such as disk 101, which rotates about a fixed axis. The disk also includes tracks, which are used to store information thereon. The disk rotates at 7,200 RPM to greater than about 10,000 depending upon the embodiment. The disk, commonly called a platter, often includes a magnetic media such as a ferromagnetic material, but can also include optical materials, common coated on surfaces of the disk, which become active regions for storing digital bit information. Overlying the disk is head gimbal assembly or HGA 103, which operates and controls a slider 109 coupled to a read/write head. The head gimbal assembly is coupled to suspension 107 which couples to an arm 105. The arm is coupled to a voice coil motor or VCM, which moves the head assembly about a pivot point in an annular manner. The VCM can move at a frequency of up to about 1 kHz. Preferably, for high track density, e.g. 250 k TPI, the speed is at least 5 kHz, but can also be greater in certain embodiments. Further details of the head assembly are provided throughout the present specification and more particularly below.

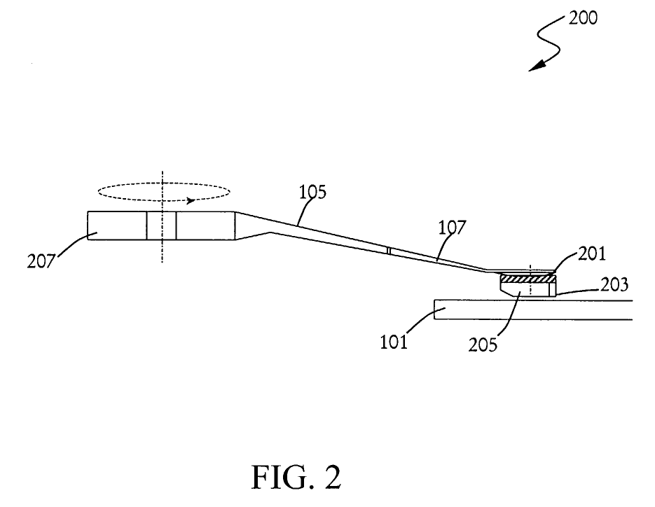

FIG. 2 is a more detailed side-view diagram of a disk drive arm assembly 200 according to an embodiment of the present invention. This diagram is merely an example, which should not unduly limit the scope of the claims herein. One of ordinary skill in the art would recognize many other variations, modifications, and alternatives. Like reference numerals are used in this diagram as certain other diagrams herein, which should not be limiting. As shown, the assembly includes suspension 107 coupled to arm 105 coupled to voice coil motor 207. Slider 205 is coupled to another end of the suspension. The slider includes read/write head 203. The head is positioned over a track on the platter 101, which is among a plurality of tracks on the disk.

Preferably, the head gimbal assembly also includes a micro actuator device 201 coupled between the tongue portion of the gimbal and the slider 205. The actuating device moves the head in a direction normal to a direction of the track according to a specific embodiment. Preferably, the actuating device is made of a PZT material, which is operable in the shear mode, but can also be in other modes. The PZT material moves in a spatial manner when voltage has been applied in a selective manner. Such movement allows the read/write head to move, which is used to align the head in a selected manner to one or more of the tracks. Further details of a present operation of the apparatus can be found throughout the present specification and more particularly below.

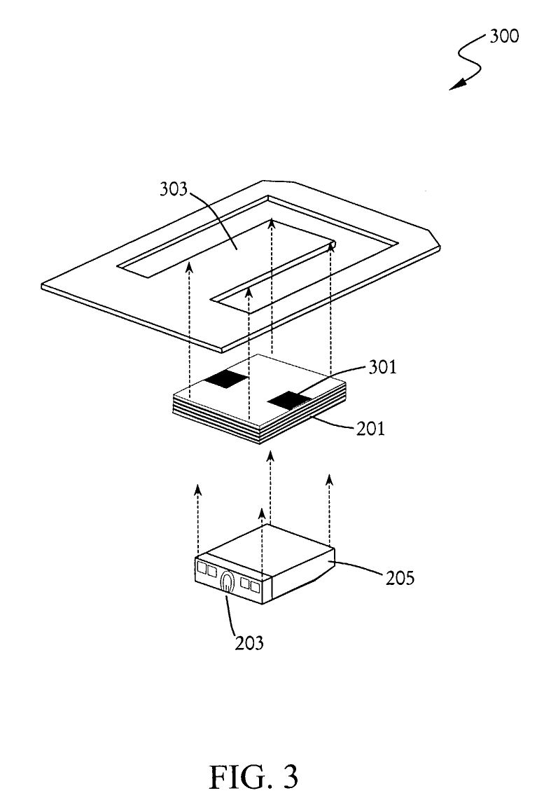

FIG. 3 is a detailed diagram of a slider assembly 300 according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the slider assembly 300 includes slider 205 coupled to actuating device 201. The actuating device is coupled to the read/write head element 203. The slider assembly includes the tongue portion 303 of the gimbal, which includes opening to provide desired stiffness that allows the slider to pitch and roll. The slider is assembled to the actuator using adhesive material such as UV cure epoxy. The slider and actuator assembly is attached to the gimbal tongue by soldering or using conductive epoxy between the contact pads on the gimbal and the contact pads on the actuator 301. The actuating device and the read/write head portion are free to move. Further details of the slider assembly are provided throughout the present specification.

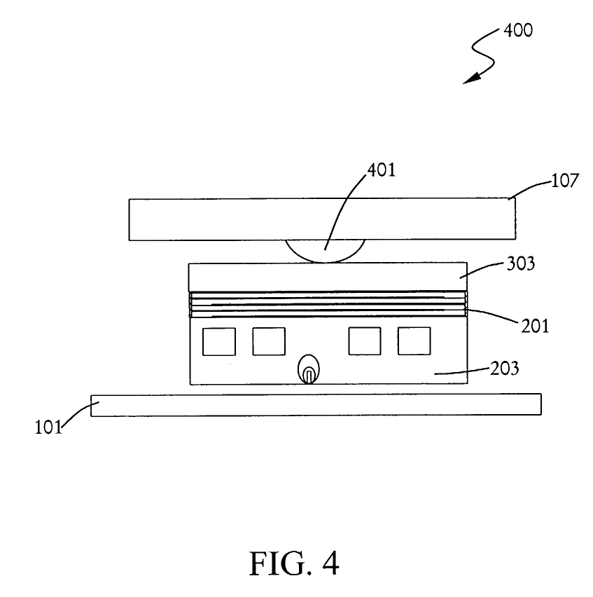

FIG. 4 is a detailed front-view diagram of a slider and head assembly 400 according to an embodiment of the present invention. This diagram is merely an example, which should not unduly limit the scope of the claims herein. One of ordinary skill in the art would recognize many other variations, modifications, and alternatives. As shown, the slider assembly 400 includes slider/head element 203 coupled to actuating device 201. The actuating device is attached to the gimbal tongue 303 which is coupled to the loadbeam 107 via a dimple 401. The dimple provides a pivotal point for the read/write head to pitch, roll and rotate according a specific embodiment. The dimple is shaped as an elevated region, which has a small contact region to the tongue portion. Preferably, the actuating device is made of a PZT material, which is operable in the shear mode, but can also be in other modes. The actuating device moves the read/write head in a direction normal to a direction of the track according to a specific embodiment.

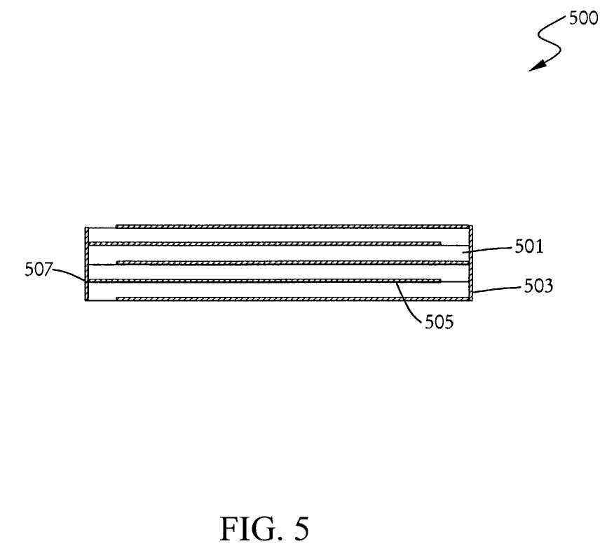

FIG. 5 is a detailed diagram of multilayer PZT actuator structure 500 according to an embodiment of the present invention. The actuating device includes a plurality of thin film PZT layers, which are coupled to each other. Each of the layers 501 includes separating electrodes 505. One end of the electrodes is coupled to common electrode 503 and the other end of the electrodes is coupled common electrode 507 with opposite polarity. As noted, further details of the slider assembly are provided throughout the present specification.

A method according to an embodiment of the present invention may be outlined as follows:

1. Provide an improved disk drive apparatus;

2. Move a movable member about a fixed position to move a read/write head coupled to a slider to a selected track on a disk;

3. Adjust a position of the read/write head using an actuating device coupled between the read/write head and the slider, whereupon the actuating step moves the read/write head relative in a manner normal to the track on the magnetic disk;

4. Position the read/write head on the track using a finer and more accurate alignment than the primary actuating device such as a VCM;

5. Position the read/write head on the track using a faster alignment than the primary actuating device such as a VCM; and

6. Perform other steps, as desired.

The above sequence of steps provides a method according to an embodiment of the present invention. As shown, the method includes using an actuating device coupled between the read/write head and the slider to provide fine and quick alignment of the read/write head onto the disk track. Further details of the method are provided throughout the present specification and more particularly below.

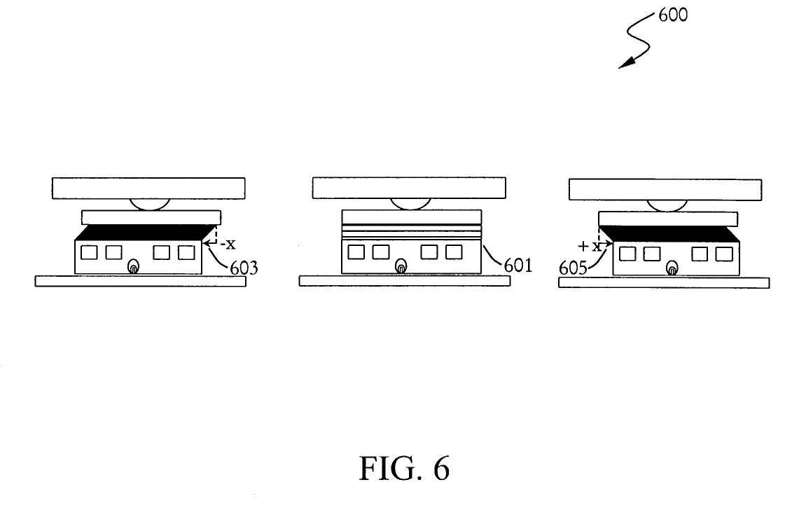

FIG. 6 is a detailed diagram of piezoelectric actuating device operating modes 600 according to embodiments of the present invention. This diagram is merely an example, which should not unduly limit the scope of the claims herein. One of ordinary skill in the art would recognize many other variations, modifications, and alternatives. As shown, the diagram includes various embodiments 601, 603, 605, which relate to changes in position based upon various actuation modes of the actuating device according to a method of the present invention. The multilayer piezoelectric actuator moves the read/write head by a distance x defined by N*V*d₁₅, where the plurality of piezoelectric material layers include N layers, where N is an integer, V is an applied voltage and d₁₅ is shear mode piezoelectric coefficient.

More particularly, the method includes adjusting a position of the read/write head using an actuating device coupled between the read/write head and the slider. The actuating step moves the read/write head relative in a manner normal to the track on the magnetic disk to align the read/write head on the track using a finer and faster alignment of the read/write head than the VCM. When the applied voltage V is zero, there is no displacement generated by the piezoelectric actuator, the read/write head remain in a center position 601. When a negative voltage is applied to the actuator, the piezoelectric multilayer material shifts to the negative x-direction as shown by reference numeral 603, that causes the read/write head also to move the left normal to the media track on the disk. Alternatively, when a positive voltage is applied, the read/write head moves to a positive x-direction, as shown by reference numeral 605. Preferably, the movement of the read/write head can be about 1 micron and less, depending upon the embodiment.

Additional degree of freedom (DOF) of the read/write head can be obtained by stacking additional PZT element with different poling orientation. As merely an example, the read/write head can be moved vertical relative to the track on the magnetic disk to adjust flying height in operation.

Depending upon the embodiment, the actuation can include a series of discrete steps or be continuous such as analog. As merely an example, the steps can be about few nanometers (e.g., 2-4) and less depending upon the embodiment. Alternatively, the steps can be continuous or combined with continuous motion depending upon the embodiment. A characteristic time for moving the head can be about 0.2 to 0.1 microseconds but can also be greater, depending upon the application.

One of ordinary skill in the art would recognize many other variations, modifications, and alternatives. The above example is merely an illustration, which should not unduly limit the scope of the claims herein. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A disk drive apparatus, the disk drive apparatus comprising:
a platter operably coupled to a servo drive device, the servo drive device being adapted to rotate the platter about a fixed axis;
a support member operably coupled to the platter to move the support member about one or more active regions on a surface of the platter;
a read/write head including an active portion and a support portion, the support portion being coupled to the support member, the active portion being operably coupled to the platter to read and/or write information to the surface of the platter;
a piezo electric actuating material being coupled between the support portion of the read/write head and the support member;
a first electrode coupled to a first side of the piezo electric actuating material;
a second electrode coupled to a second side of the piezo electric actuating material;
a drive device coupled to the first electrode and the second electrode to actuate the piezo electric actuating material in substantially a shear mode of operation of the piezo electric actuating material to adjust a position of the read/write head within one micron of a selected portion of the one or more active regions on the surface of the platter;
wherein the first electrode and the second electrode are configured in a manner substantially parallel to a poling orientation of the piezo electric actuating material to cause the adjustment of the piezo electric actuating material in the shear mode of operation.

2. The apparatus of claim 1 wherein the piezo electric actuating material is PZT.

3. The apparatus of claim 1 wherein the first electrode and the second electrode are made of a conductive material.

4. The apparatus of claim 1 wherein the one or more active regions is a data track on a media of the platter.

5. The apparatus of claim 1 wherein the piezo electric actuating material is about less than one millimeters in a first dimension and a thickness of less than 250 microns.

6. The apparatus of claim 1 further comprising a feed back device coupled to the drive device to provide information to the drive device.

7. The apparatus of claim 1 further comprising a electromagnetic drive device coupled to the support member, the electromagnetic drive device providing movement of the support member to move the read/write head about the one or more active regions of the platter.

8. The apparatus of claim 7 wherein the electromagnetic drive device comprises a voice coil motor.

9. The apparatus of claim 1 wherein the one or more active regions includes a critical dimension of less than 100 nanometers for a platter density of 100 Gb/in2.

10. The apparatus of claim 1 wherein the platter rotates more than 10,000 revolutions per minute.

11. A method for manufacturing a support member for a read/write head, the method comprising:
providing a support substrate;
coupling a piezo electric material having a predetermined thickness onto a surface of the substrate, the piezo electric material including an electrode material overlying the surface of the substrate;
forming a conductive layer overlying the piezo electric material;
patterning the conductive layer to form one or more conductive regions;
patterning a backside surface of the support substrate to remove a portion of the support substrate and a portion of the predetermined thickness of the piezo electric material up to one or more portions of the one or more conductive regions to substantially free the one or more portions of the one or more conductive regions from the support substrate while maintaining a selected portion of the piezo-electric material intact.

12. The method of claim 11 wherein the conductive substrate is stainless steel.

13. The method of claim 11 wherein the one or more conductive regions are electrical conductive regions.

14. The method of claim 11 wherein the piezo electric material is a PZT material.

15. The method of claim 11 wherein the patterning of the backside of the substrate includes an etching process.

16. The method of claim 11 wherein the electrode material is conductive.

17. The method of claim 11 wherein the support substrate is 304 stainless steel.

18. The method of claim 11 wherein the patterning of the conductive layer includes an etching process.

19. A disk drive apparatus, the disk drive apparatus comprising:
a platter operably coupled to a servo drive device, the servo drive device being adapted to rotate the platter about a fixed axis;
a support member operably coupled to the platter to move the support member about one or more active regions on a surface of the platter;
a read/write head including an active portion and a support portion, the support portion being coupled to the support member, the active portion being operably coupled to the platter to read and/or write information to the surface of the platter;
a piezo electric actuating material being coupled between the support portion of the read/write head and the support member;
a first electrode coupled to a first side of the piezo electric actuating material;
a second electrode coupled to a second side of the piezo electric actuating material;
a drive device coupled to the first electrode and the second electrode to actuate the piezo electric actuating material in substantially a shear mode of operation of the piezo electric actuating material to adjust a position of the read/write head within one micron of a selected portion of the one or more active regions on the surface of the platter, the piezoelectric actuating material comprising a plurality of piezoelectric material layers, the plurality of piezoelectric material layers include N layers, where N is an integer; whereupon the piezoelectric actuating material moves the read/write head by a distance x defined by N*V*d15, where V is an applied voltage and d15 is sheer mode piezoelectric coefficient;
wherein the first electrode and the second electrode are configured in a manner substantially parallel to a poling orientation of the piezo electric actuating material to cause the adjustment of the piezo electric actuating material in the shear mode of operation.
